(19) United States
(12) Patent Application Publication
(10) Pub. No.: US 2012/0246788 A1
(43) Pub. Date: Oct. 4, 2012

(54) Multipurpose Cooling and Trauma Attenuating Devices and Associated Methods

(76) Inventors: Jeremy L. Harrell, Hendersonville, TN (US); Charles M. Letterman, Hendersonville, TN (US); Scott F. Leftwich, Brentwood, TN (US)

(21) Appl. No.: 13/432,739

(22) Filed: Mar. 28, 2012

Related U.S. Application Data
(60) Provisional application No. 61/468,100, filed on Mar. 28, 2011.
(60) Provisional application No. 61/587,104, filed on Jan. 16, 2012.

(51) Int. Cl. F41H 1/02; F16F 9/04; A41D 27/00

(52) U.S. Cl. 2/2.5; 2/243.1; 267/140.11

(57) ABSTRACT

A panel apparatus for positioning between a human body and a region of body armor absorbs impact energy associated with a projectile or other object impacting the body armor. The panel is also operable to absorb overpressure energy associated with a blast wave from an explosive device such as an improvised explosive device or a bomb. The panel may be secured to an interior of conventional tactical body armor, body armor carriers, or the like. The panel includes a multilayer construction and includes an inflatable primary gas chamber and a separate non-inflatable secondary gas chamber in some embodiments. The primary and secondary gas chambers are stacked in substantially parallel planes and are oriented substantially parallel to the body armor.

### CROSS-REFERENCES TO RELATED APPLICATIONS

This application claims benefit of the following patent applications which are hereby incorporated by reference: Ser. No. 61/468,100 for Multipurpose Cooling and Trauma Attenuating Device and Associated Methods filed Mar. 28, 2011, and Ser. No. 61/587,104 for Multipurpose Cooling and Trauma Attenuating Panel and Associated Methods filed Jan. 16, 2012.

### BACKGROUND

The present disclosure relates generally to protective body armor and more particularly to devices and methods for passively cooling or insulating a wearer and also for reducing bodily trauma associated with various types of impacts.

Conventional personal protective equipment, or body armor, is typically used to prevent bodily injury associated with impacts of various kinds. Body armor can be positioned on a wearer's body to physically block objects that may be advancing toward the wearer, such as bullets, fragments from a nearby explosion or other types of debris that may fly through the air toward the wearer. Conventional body armor generally includes one or more rigid plates or pads that are strapped to a user's body. The plates can be made of a variety of materials known in the art. Plates or pads of this nature can include metal or other natural or synthetic materials.

One problem associated with conventional body armor is heat dissipation away from the wearer. Body armor generally prevents body heat convection away from the wearer, especially in hot and arid conditions such as those experienced in desert combat operations. Individuals who wear conventional body armor in such environments can experience accelerated fatigue and diminished performance due to heightened body temperature due to the presence of body armor on the wearer's body.

Another problem associated with conventional body armor includes blunt trauma resulting from an impact. Often, a projectile or fragment will impact a piece of body armor and will be stopped, thereby preventing direct contact between the projectile or fragment and the wearer's body. However, the kinetic energy associated with the velocity and mass of the projectile or fragment is transferred to the body armor and consequently to the individual wearing the body armor. This transfer of energy to the individual can result in severe mechanical trauma to the region of the wearer's body positioned near the impact zone. Although the body armor may stop the fragment or projectile, the trauma associated with the impact can lead to serious bodily injury or death to the wearer. Such trauma can injure soft tissue and internal organs including the heart, lungs, kidneys, liver, stomach, brain, bones and circulatory regions.

To prevent the severity of such impact trauma to the body, conventional body armor is oftentimes made thicker and denser, resulting in heavier and bulkier armor that can interfere with a wearer's range of motion. Bulky body armor of this nature can be detrimental when worn in combat or endurance situations where the heavy weight and bulk decreases the wearer's performance in the field.

Others have attempted to provide a panel or supporting material that can be positioned between a body armor pad or plate and the wearer's body. Such panels are generally configured to absorb some of the kinetic energy that is transferred to the wearer from the projectile or fragment. For example, U.S. Pat. No. 6,012,162 provides high impact absorbing body armor including a hardened outer armor section and an underlying inflatable reservoir for cushioning projectile impact.

Conventional devices for preventing body trauma associated with body armor impact are often bulky and do not provide adequate range of motion or ventilation for the wearer, resulting in overheated and uncomfortable conditions.

What is needed then is an improved device and associated methods of use and manufacture for passively or actively cooling or insulating a wearer of body armor while also absorbing energy associated with an impact or a pressure wave.

### BRIEF SUMMARY

One object of the present disclosure is to provide an apparatus for absorbing impact energy associated with a projectile or fragment impacting a piece of body armor. In some embodiments, the present disclosure provides a detachable panel that can be positioned between a piece of body armor and a user's body. The panel can include several layers defining multiple independent gas chambers for storing pressurized gas. In some embodiments, the apparatus includes a front panel for covering a user's chest and a back panel for covering a user's back. The front and back panels in some embodiments may be interchangeable for ease of use. In other embodiments, the front and back panels may be pre-formed to fit the unique curvature of each side of a user's body.

A further object of the present disclosure is to provide a panel apparatus for attachment to a body armor garment. The panel apparatus includes an outer layer including an outer fabric and a first gas barrier layer disposed on the outer fabric. A middle layer is positioned adjacent the outer layer, the middle layer including a middle fabric having first and second middle fabric sides and including a second gas barrier layer disposed on the first middle fabric side and a third gas barrier layer disposed on the second middle fabric side. An inner layer is positioned adjacent the middle layer. The inner layer includes an inner fabric having a fourth gas barrier layer disposed on the side of the inner fabric facing the middle layer. A primary gas chamber is defined between the inner layer and the middle layer. A secondary gas chamber is defined between the outer layer and the middle layer.

Another object of the present disclosure is to provide an apparatus for absorbing impact forces. The apparatus includes a first sheet including an outer fabric and a first gas barrier layer disposed on the outer fabric. A second sheet is positioned adjacent the first sheet, the second sheet including a second fabric having first and second sides and including a second gas barrier layer disposed on the first side and a second gas barrier layer disposed on the second side. A third sheet is positioned adjacent the second sheet. The third sheet includes a third fabric having a fourth gas barrier layer disposed on the side of the third sheet facing the second sheet. A primary gas chamber is defined between the second and third sheets. The outer fabric comprises a fastener.

Another object of the present disclosure is to provide a method of retrofitting a conventional body armor garment to reduce trauma to a wearer associated with an impact on the body armor garment, the method comprising the steps of: (a) attaching a first attachment fastener to the garment; and (b) securing an inflatable trauma attenuating panel directly to the first attachment fastener. The panel includes an outer layer including an outer fabric and a first gas barrier layer disposed on the outer fabric. The panel also includes a middle layer including a middle fabric having first and second middle fabric sides and including a second gas barrier layer disposed on the first middle fabric side and a third gas barrier layer disposed on the second middle fabric side. The panel also includes an inner layer including an inner fabric having a fourth gas barrier layer disposed on the side of the inner fabric facing the middle layer. A primary gas chamber is defined between the inner layer and the middle layer, and a secondary gas chamber is defined between the outer layer and the middle layer.

Yet another object of the present disclosure is to provide a kit for retrofitting a conventional body armor garment to include one or more inflatable panels for attenuating trauma forces.

A further object of the present disclosure is to provide a body armor system including a body armor garment and one or more inflatable panel devices for attenuating trauma forces incident upon a wearer of the body armor system.

Numerous other objects, features and advantages of the present disclosure will be readily apparent to those skilled in the art upon a reading of the following disclosure when taken in conjunction with the accompanying drawings.

### BRIEF DESCRIPTION OF THE DRAWINGS

FIG. 1A illustrates a plan view of an embodiment of a trauma attenuating panel in accordance with the present disclosure.

FIG. 1B illustrates a cross-sectional view of Section 1B-1B from FIG. 1A showing an embodiment of a trauma attenuating panel in accordance with the present disclosure.

FIG. 1C illustrates a detail partial cross-sectional view of Section 1C from FIG. 1B showing an embodiment of a trauma attenuating panel in accordance with the present disclosure.

FIG. 2 illustrates a plan view of an embodiment of the interior of an embodiment of a conventional body armor garment such as a carrier or a tactical vest.

FIG. 3 illustrates an elevation view of an embodiment of a rear portion of a body armor garment including an embodiment of a panel apparatus in accordance with the present disclosure disposed thereon.

FIG. 4 illustrates a plan view of an embodiment of a front portion of a body armor garment including an embodiment of a panel apparatus in accordance with the present disclosure disposed thereon.

FIG. 5 illustrates a side view of a person wearing a body armor system in accordance with the present disclosure including front and back trauma attenuating panels positioned against a wearer's body.

FIG. 6 illustrates a partial cross-sectional view of an alternative embodiment of a trauma attenuating panel in accordance with the present disclosure.

FIG. 7 illustrates a partial cross-sectional view of an embodiment of a trauma attenuating panel showing primary and secondary gas chambers in accordance with the present disclosure.

FIG. 8 illustrates a partial cross-sectional view of an embodiment of an outer layer, or first sheet.

FIG. 9 illustrates a partial cross-sectional view of an embodiment of a middle layer, or second sheet.

FIG. 10 illustrates a partial cross-sectional view of an embodiment of an inner layer, or third sheet.

FIG. 11 illustrates a partial cross-sectional view of an embodiment of a panel apparatus in accordance with the present disclosure including outer, middle and inner layers and primary and secondary gas chambers.

FIG. 12 illustrates a plan view of an outer layer, or first sheet, of a panel apparatus in accordance with the present disclosure.

FIG. 13 illustrates a plan view of first and second trauma attenuating panels with mating edges in a manufacturing configuration.

FIG. 14 illustrates a plan view of an alternative embodiment of a panel apparatus including a plurality of attachment patches.

FIG. 15 illustrates a perspective view of an embodiment of vest including a pair of panel devices secured.

FIG. 16 illustrates a plan view of an embodiment of a vest including a pair of panel devices secured together.

FIG. 17 illustrates a plan view of an embodiment of a panel device including a plurality of sensors.

### DETAILED DESCRIPTION

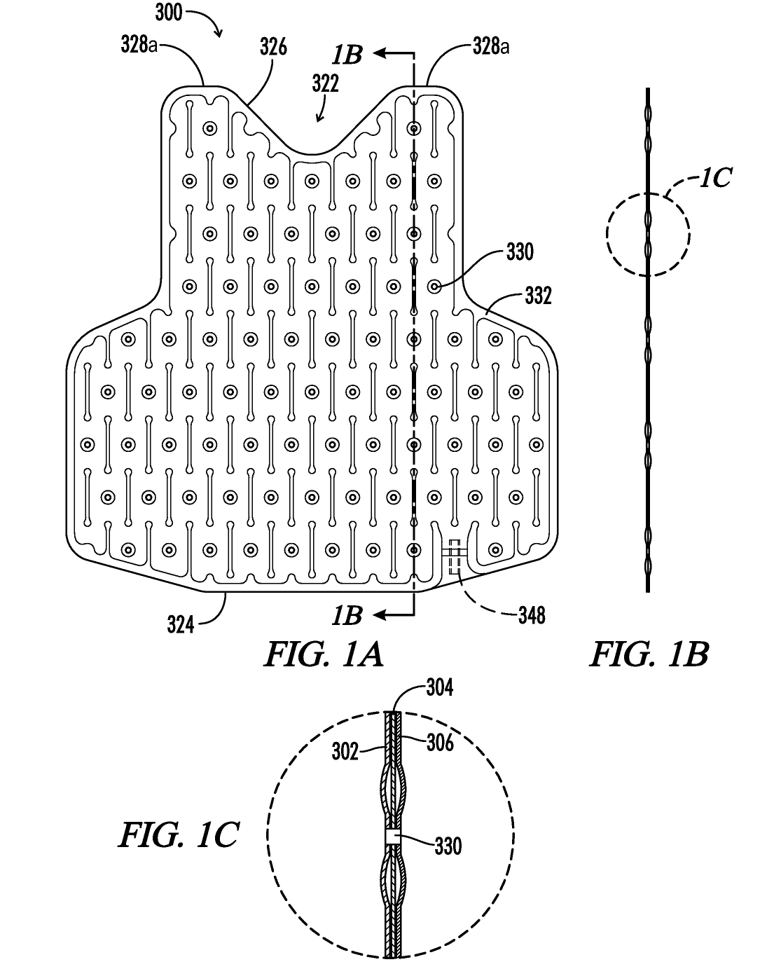

Referring now to the drawings, one embodiment of the present disclosure provides a trauma attenuating panel apparatus illustrated generally in FIG. 1A and designated by the numeral 300. It is understood that in the drawings, not all reference numbers are included in each drawing, for the sake of clarity. In addition, positional terms such as a “upper,” “lower,” “side,” “top,” “bottom,” “vertical,” “horizontal,” “inner,” “outer,” “middle,” etc. refer to the apparatus when in the orientation shown in the drawing. The skilled artisan will recognize that objects in accordance with the present disclosure can assume different orientations when in use.

Referring further to FIG. 1A, one embodiment of a panel apparatus 300 in accordance with the present disclosure is illustrated. Panel 300 is generally shaped to fit against a human torso in some embodiments. In other embodiments, panel 300 may be shaped to fit against other parts of a human body, such an arm, leg, head, hand, foot, neck, etc. Also, panel 300 may be shaped to fit against an animal's body such as a dog or a horse. Panel 300 includes a lower edge 324 and an upper edge 322 having a first shoulder region 328a and a second shoulder region 328b. A recessed neck region 322 is defined between first and second shoulder regions 328a, 328b in some embodiments. Panel 300 is generally formed of several layers of woven or non-woven material layers secured together and including at least one primary gas chamber defined between at least two of the layers. A plurality of vent holes 330 may be defined in panel 300. In some embodiments, each vent hole 330 is a clearance hole extending completely through panel 300. In other embodiments, panel 300 may be formed without any vent holes. Additionally, panel 300 includes a plurality of welds 332. Each weld 332 includes a region where any two or more layers of the multiple layers that make up panel 300 are joined together. Each weld may be formed in some embodiments by RF welding the various layers together. Other material joining techniques known in the art may also be used to join the separate layers. Each vent hole 330 also generally includes an annular weld surrounding each vent hole 330 to prevent pressurized gas stored between layers to escape through the vent hole 330.

Referring to FIG. 1B and FIG. 1C, in some embodiments, panel 300 includes at least three discrete layers joined together to form a multi-layer panel. A first layer, or outer layer 302 includes a first material. Outer layer 302 may also be described as a first sheet 302. A second layer, or middle layer 304, is positioned adjacent outer layer 302. Middle layer 304 may be described as a second sheet. A third layer, or inner layer 306, is positioned adjacent middle layer 304. Inner layer 306 may be described as a third sheet.

In some embodiments, each individual layer 302, 304, 306 includes multiple materials and may include a unique construction as compared to the other layers.

Outer layer 302 includes an outer fabric 336 and a first gas barrier layer 334 disposed on the outer fabric 336, as seen in FIG. 10. In some embodiments, the outer fabric 336 may include a hook and loop compatible fabric such as a Velcro-compatible material. For example, outer layer 302 is generally configured to be secured to a body armor garment such as a ballistic vest, a ballistic vest liner, a body armor carrier, a helmet, or any other body armor garment. The term body armor garment may be defined as any type of structure used to dampen an impact force such as conventional body armor plates and vests, helmets, impact-resistant clothes such as reinforced shirts or pants or other body armor equipment known in the art for humans or for animals. As seen in FIG. 10, in some embodiments, outer layer 302 may include multiple sub-layers. For example, in some embodiments outer layer 302 includes an outer fabric 336 including a hook and loop compatible material attached to a first gas barrier layer 334.

Outer fabric 336 includes a hook and loop compatible material in some embodiments. Outer fabric 336 may include a hook fabric or a loop fabric for use in a hook and loop fabric fastener system such as Velcro.

First gas barrier layer 334 in some embodiments includes a gas impermeable substance such as a urethane, which may also be described as polyurethane. In other embodiments, first gas barrier layer 334 may include a urethane, or polyurethane, sheet attached or bonded to outer fabric 336. First gas barrier layer 334 may be coated directly onto the backside of outer fabric 336 to form a gas-impermeable backing, or gas barrier, on outer fabric 336. Outer layer 302 generally faces away from a wearer. First gas barrier layer 334 includes urethane or polyurethane film and is extruded directly onto outer fabric 336 in other embodiments. In some embodiments, first gas barrier layer 334 includes a urethane or a polyurethane coating applied to outer fabric 336 to form outer layer 302. In various other embodiments, first gas barrier layer 334 includes other suitable gas barrier materials known in the art such as vinyl, rubber, PVC, PET, PVA or other suitable materials.

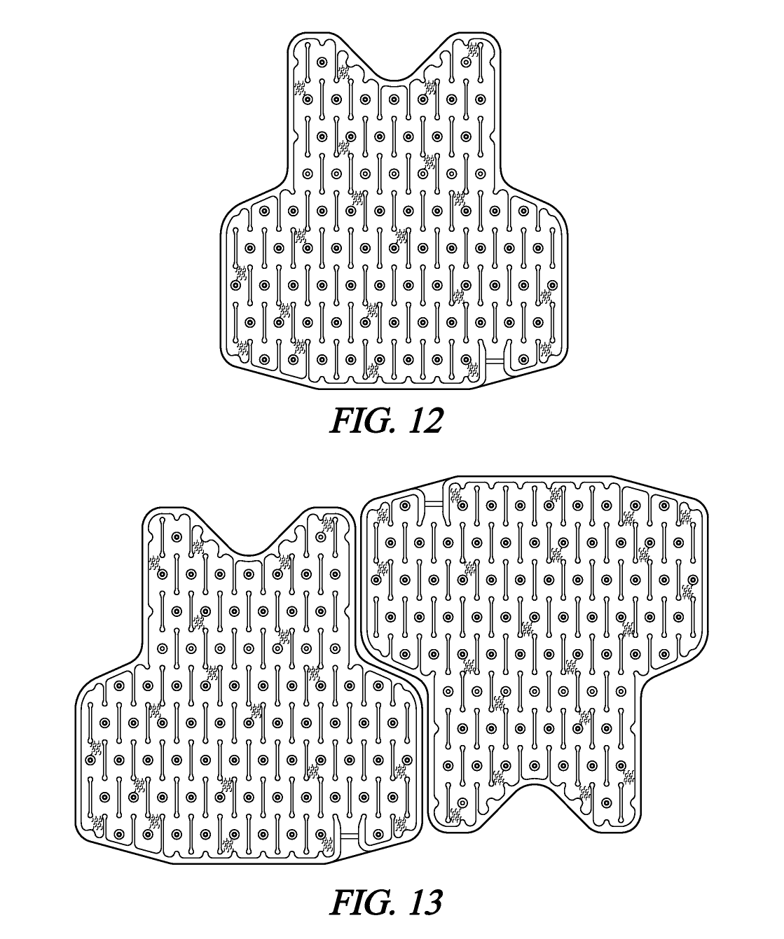

In some embodiments, outer layer 302 includes a hospital grade female hook and loop compatible fabric with a urethane backing. In some embodiments, the hook and loop compatible fabric covers substantially the entire exterior surface of panel 300, as seen in FIG. 12, thereby allowing attachment of a corresponding hook and loop fastener at any location onto outer layer 302. By providing substantially an entire surface of hook and loop fabric on outer layer 302 of vest 300, a user may be able to interchangeably secure panel 300 to various garments or tactical equipment with different hook and loop fastener patch locations. It is noted that in some embodiments the weld regions do not retain hook and loop compatible functionality following RF welding.

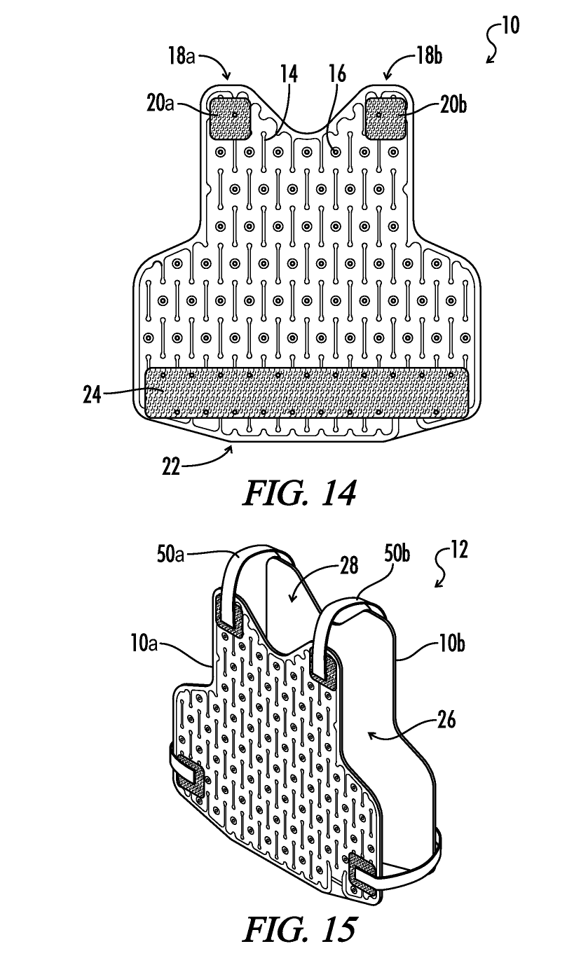

In other embodiments, only a portion of outer layer 302 includes a hook and loop compatible fabric. For example, as seen in a second embodiment in FIG. 14-16, in some embodiments, one or more outer patches can be positioned on the exterior of panel 10. A first shoulder patch 20a is attached to first shoulder region 18a, and a second shoulder patch 20b is attached to second shoulder region 18b. First and second shoulder patches 20a, 20b can include a male or female hook-and-loop compatible fabric such as a Velcro-type material. Additionally, a bottom patch 24 is attached to panel 10 at the lower edge 22. Bottom patch 24 can also include a male or female hook-and-loop compatible fabric such as a Velcro-type material. In some embodiments, vent holes can also be defined to extend through one or more of the patches 20a, 20b, 24.

Referring now to FIG. 15, an embodiment of a vest 12 is generally illustrated. Vest 12 includes a first panel 10a and a second panel 10b. First panel 10a can include a front panel, and second panel 10b can include a back panel. First panel 10a is configured to fit against a human's chest, and back panel 10b is configured to fit against a human's back. The first and second panels 10a, 10b can be releasably secured together using a plurality of straps. For example, a first shoulder strap 50a can include a male or female hook-and-loop compatible fabric fastener region configured to engage first shoulder patch 20a. First shoulder strap 50a also releasably engages a shoulder patch positioned in a similar location on second panel 10b. Similarly, a second shoulder strap 50b can include a male or female hook and loop compatible fabric fastener region configured to engage second shoulder patch 20b. Second shoulder strap 50b also releasably engages a shoulder patch positioned in a similar location on second panel 10b. Thus, first and second shoulder straps 50a, 50b are releasably securable to both first and second panels 10a, 10b. One or more waist straps 52 can be used to secure the lower edges of first and second panels 10a, 10b in a similar fashion. As seen in FIG. 15, a side gap 26 is formed between first and second panels 10a, 10b. Side gap 26 is shaped for passage of a wearer's arm. A neck gap 28 is also defined between first and second panels 10a, 10b and is shaped for passage of the wearer's neck. When the vest 12 is positioned on a wearer's body, vest 12 can provide neutral or positive buoyancy to a conventional body armor system that is positioned on the exterior of the vest 12 on the wearer's body.

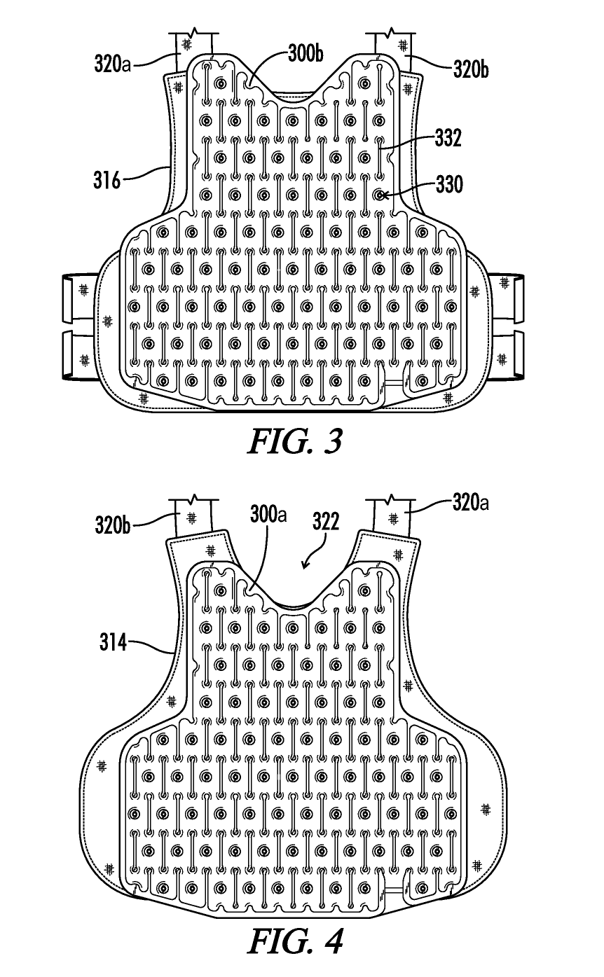

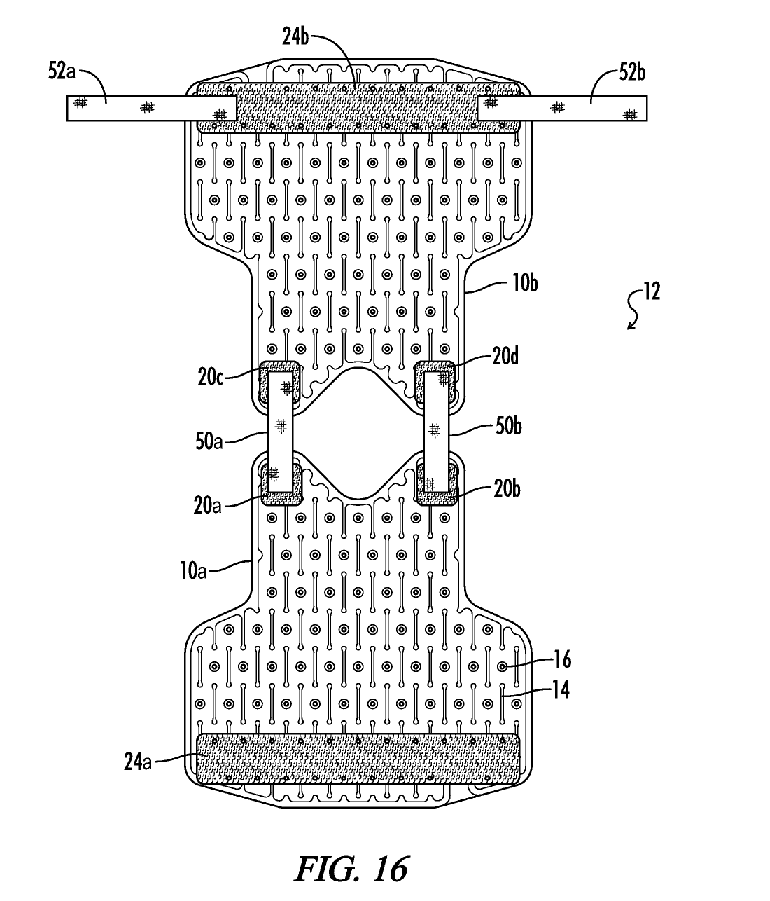

Referring now to FIG. 16, in some embodiments, a vest 12 includes a first panel 10a and a second panel 10b. A plan view of first and second panels is illustrated generally in FIG. 15. First panel 10a includes first and second shoulder patches 20a, 20b, and second panel 10b includes third and fourth shoulder patches 20c, 20d. First shoulder strap 50a is attached to first and third shoulder patches 20a, 20c, and second shoulder strap 50b is attached to second and fourth shoulder patches 20b, 20d. First panel 10a also includes a first bottom patch 24a, and second panel 10b includes a second bottom patch 24b. Each patch can include a hook-and-loop compatible fabric. First and second waist straps 52a, 52b are securable to first and second waist patches 24a, 24b for releasably securing first and second panels together. As seen in FIG. 3, one or more welds 14 extend through one or more patches 20a, 20b, 24a, 20c, 20d, 24b. Such welds are used to secure each patch to its corresponding panel. By welding each patch directly to its panel, expense and time associated with manufacture can be reduced. Additionally, conventional stitching may be used in addition to on-patch welds to secure the various patches to the panels. However, by providing a welded connection between the panels and patches, improved performance can be achieved over other designs that include only stitching. Also seen in FIG. 3, in some embodiments, one or more vent holes 16 extend through each patch. Vent holes 16 extending through each patch allow for ventilation in the areas on each panel covered by a patch. Additionally, vent holes 16 extending through each patch allow for forced air convection to pass through each panel area covered by a patch. Vest 12 can generally be positioned on a user's body before body armor is fitted over the vest.

Middle layer 304 in some embodiments may include a woven material coated on both sides with gas barrier layers such as a polyurethane coating. For example, in some embodiments, seen for example in FIG. 9 and FIG. 11, middle layer 304 includes a middle fabric 340. In some embodiments, middle fabric 340 includes a woven nylon material. In some embodiments, middle fabric 340 includes a fabric linear mass density of between about 100 and about 1000 denier. In further embodiments, middle fabric 340 includes a woven nylon material having a fabric linear mass density of about 200 denier. In additional embodiments, middle fabric 340 includes a woven nylon material having a fabric linear mass density of about 500 denier. Middle fabric 340 or outer fabric 336 or both may include reinforcing fibers such as spectra, dyneema, aramid or other suitable reinforcing fibers in additional embodiments.

Middle fabric 340 includes a first side having a second gas barrier layer 338 disposed thereon and a second side having a third gas barrier layer 342 disposed thereon to form middle layer 304. Each third and fourth gas barrier layers 338, 342 may include a urethane or polyurethane material deposited directly onto respective sides of middle fabric 340 to form a gas barrier for preventing gas from travelling through middle layer 304. In some embodiments, both first and gas barrier layers 338, 342 are extruded onto middle fabric 340 of middle layer 304. Each gas barrier layer may alternatively include a urethane or polyurethane film bonded to the middle fabric 340. In various other embodiments, third and fourth gas barrier layers 338, 342 may include other suitable gas barrier materials known in the art such as vinyl, rubber, PVC, PET, PVA or other suitable materials.

Inner layer 306 generally includes an inner fabric 346 and a fourth gas barrier layer 344. Fourth gas barrier layer 344 may be coated directly onto inner fabric 346 in some embodiments. In other embodiments, fourth gas barrier layer 344 may be extruded onto inner fabric 346. In other embodiments, fourth gas barrier layer 344 may include a urethane or a polyurethane film bonded to inner fabric 346. Inner fabric 346 in some embodiments includes a woven nylon material. In some embodiments, inner fabric 346 includes a woven nylon material having a fabric linear mass density between about 100 denier and about 1000 denier. In further embodiments, inner fabric 346 includes a woven nylon material having a fabric linear mass density of about 200 denier. In additional embodiments, inner fabric 346 includes a woven nylon material having a fabric linear mass density of about 500 denier. Inner fabric 346 may include a reinforcing material such as spectra, dyneema or aramid fibers, or other suitable reinforcing fibers, in some embodiments. Fourth gas barrier layer 344 generally provides a gas barrier on inner fabric 346 of inner layer 306 to prevent gas from passing through inner layer 306.

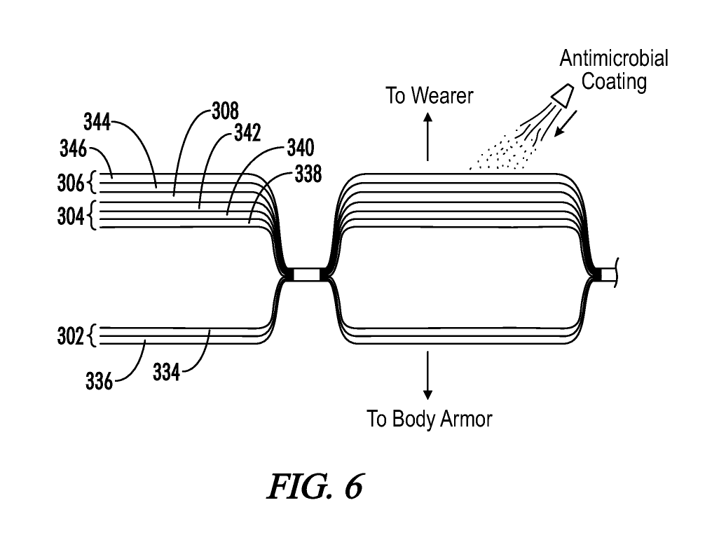

In some embodiments, inner layer 306 includes an antimicrobial coating disposed on the surface of inner fabric 346 on the side opposite fourth urethane coating 344. For example, in some embodiments, the anti-microbial coating includes a nano-crystal coating having the trade name Oxi-Titan. The nano-crystal coating may be sprayed directly onto inner fabric 346 in a thickness of between about 5 and about 10 nanometers and allowed to dry, as seen in FIG. 6. In some embodiments, a desired nano-crystal layer thickness of about seven nanometers provides desired performance characteristics. The nano-crystal coating provides increased surface area contact with a wearer's body, improves evaporation of moisture, includes a hydrophobic surface to prevent water droplet formation, provides an antimicrobial and antifungal surface and/or increases heat transfer in some embodiments. In additional embodiments, the anti-microbial coating includes a photocatalytic agent. The antimicrobial coating may be applied to either side of the panel apparatus or to both sides of the panel apparatus.

Each of outer, middle and inner layers 302, 304, 306, or first, second and third sheets, respectively, may be assembled separately prior to being joined together as a panel apparatus 300 in some embodiments. For example, outer layer 302 is assembled by forming a first gas barrier layer 334 on an outer fabric 336 such as a male or female hook and loop compatible fabric. Middle layer 304 is separately formed by securing second and third gas barrier layers 338, 342 on a middle fabric 340 such as a woven nylon material. Inner layer 306 is also separately formed by forming a fourth gas barrier layer 344 on an inner fabric 346 such as a woven nylon material. Each of the outer, middle, and inner layers 302, 304, 306 may be pre-formed and provided as separate rolls or sheets of material prior to panel apparatus 300 construction.

During panel construction, each of outer, middle and inner layers 302, 304, 306 are spread out on a surface such that middle layer 304 is positioned between outer and inner layers 302, 306. Outer layer 302 is positioned relative to middle layer 304 such that first gas barrier layer 324 on outer layer 302 is facing second gas barrier layer 338 on middle layer 304. Also, inner layer 306 is positioned relative to middle layer 304 such that third gas barrier layer 342 on middle layer 304 faces fourth gas barrier layer 344 on inner layer 306. An embodiment of this configuration is illustrated generally in FIG. 11.

During construction, the individual layers are all cut to shape using a die. The layers may be cut to shape either before the layers are joined together or after the layers are joined together. The discrete layers are layered in the desired pattern and are dielectrically welded together at each weld location. The welding process may be referred to as a conventional RF welding process in some applications. The outer and middle layers may be retained in a corrugated configuration during the welding process to define the primary gas chamber in some embodiments. However, in other embodiments, the layers may be joined without providing any pre-defined corrugation pattern. The dielectric welding press can include a die punch to cut the vent holes passing through the panel in the same welding procedure.

The three layers 302, 304, 306, as illustrated in FIG. 11 may then be joined together using a conventional joining procedure. In some embodiments, the three layers 302, 304, 306 are stacked as individual sheets, stamped in a press, and RF-welded at desired weld locations, forming a weld pattern as seen in FIG. 1A. A conventional RF-welding procedure may be used to join the three layers together, forming a plurality of weld locations across the body of the panel as well as a welded perimeter. Each weld location 332 includes a region where first, second and third layers 302, 304, 306 are joined together in a gas-impermeable seal. In some embodiments, the radio-frequency welding process is adapted for joining urethane or polyurethane materials. In such embodiments, wherein each gas barrier layer in the panel includes a urethane or a polyurethane material, an RF welding procedure may be used to provide an optimized welded assembly having desired characteristics. The multiple layers having been welded together may then be cut to a desired panel shape, as seen in panel 300 in FIG. 1A and also as seen in FIG. 13.

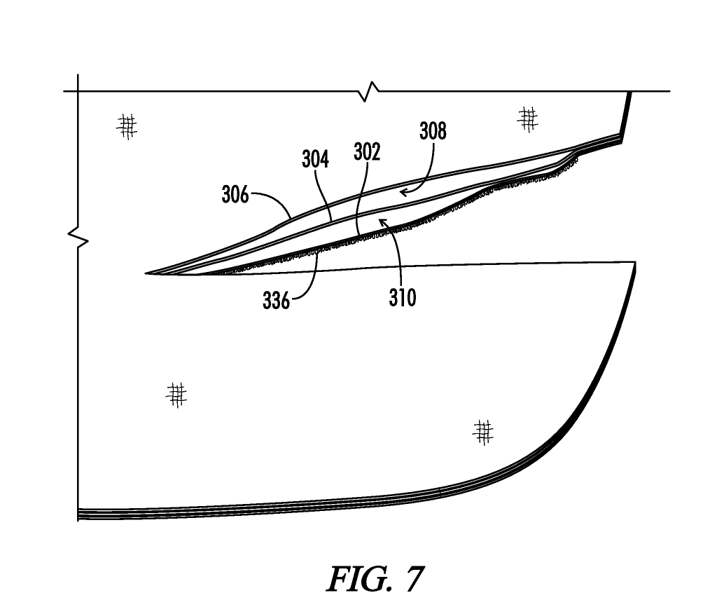

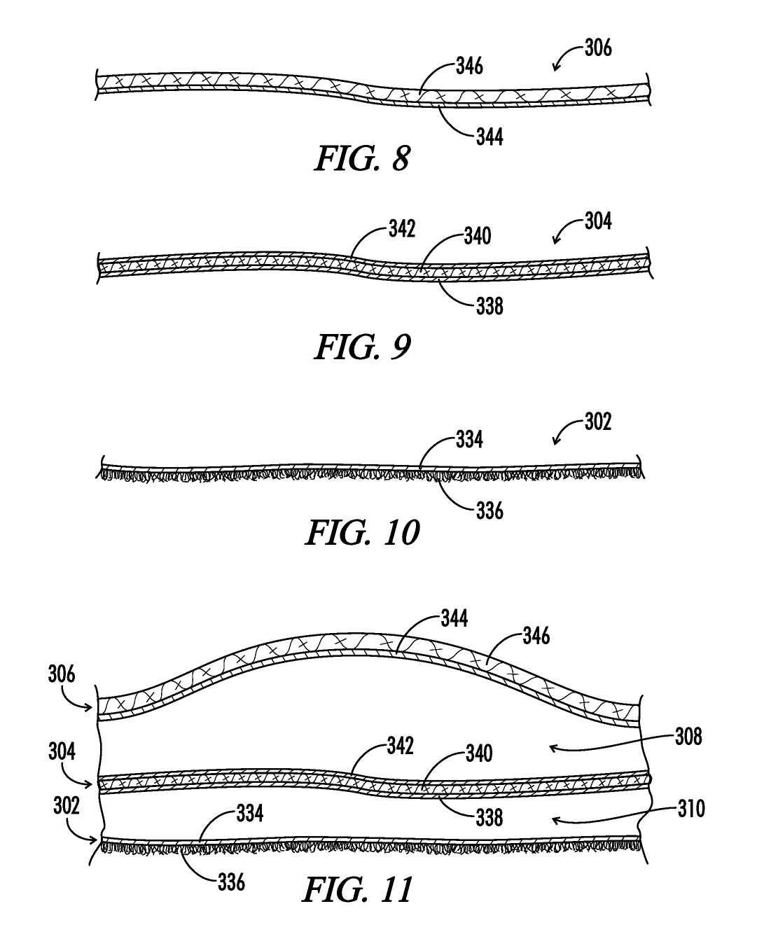

During the welding process, a primary gas chamber 308, seen for example in some embodiments in FIG. 7 and FIG. 11, is formed between inner layer 306, or third sheet, and middle layer 304, or second sheet. Primary gas chamber 308 may be selectively inflated or deflated using a valve 348 on panel 300, seen in FIG. 1A. Valve 348 includes an opening, or port, in panel 300 in fluid communication with primary gas chamber 308. Valve 348 may be coupled to a pressure source such as a manual or powered pump. A filler gas may be introduced into primary gas chamber 308 by forcing the gas into primary gas chamber 308 through valve 348. As such, primary gas chamber 308 is selectively inflatable. A gas chamber is selectively inflatable where the chamber is configured to be inflated to a desired pressure in a controlled manner. In some embodiments, primary gas chamber 308 is configured to be inflated to a pressure between about 10 psig and about 100 psig. In further embodiments, primary gas chamber 308 is configured to be inflated to a pressure between about 10 psig and about 50 psig. In additional embodiments, primary chamber 308 is configured to be inflated to a pressure between about 20 psig and about 25 psig. The pressure rating of primary gas chamber 308 may depend on the thicknesses and other material properties of the materials chosen for the outer, middle and inner layers 302, 304, 306. Various filler gases may be used to inflate primary chamber 308 in different embodiments of panel 300 to provide various performance characteristics. In some embodiments, primary gas chamber 308 may be filled with air, nitrogen, helium, or other suitable inert gases known in the art.

In further embodiments, the present disclosure provides a trauma attenuating panel including a primary gas chamber 308 configured to be filled with a filler gas having a pressure between about 10 and about 50 psig. It has been discovered that, unexpectedly, a primary gas chamber pressure of between about 20 psig and about 25 psig may provide enhanced trauma attenuation when primary gas chamber is filled with air or nitrogen in some embodiments. In some experimental tests, a backface signature reduction of around 60% was achieved using a primary chamber inflated with a filler gas having a pressure of between about 20 psig and about 25 psig. In other embodiments, primary gas chamber is configured to be filled with a filler gas having a gas pressure between about 10 psig and about 100 psig to achieve desired attenuation performance.

A secondary gas chamber 310 may be formed between middle layer 304, or second sheet, and outer layer 302, or first sheet, in some embodiments. Unlike primary gas chamber 308, in some embodiments, secondary gas chamber 310 is not coupled to an opening, or port, in panel 300. As such, secondary gas chamber 310 includes a finite volume of gas that cannot be increased or decreased in a controlled manner. Secondary gas chamber 310 in some embodiments is trapped between two adjacent layers during the RF welding assembly procedure. During the process of joining outer layer 302 to inner layer 304, a small amount of gas becomes trapped between first gas barrier layer 334 on outer layer 302 and second gas barrier layer 338 on middle layer 304. That amount of gas is retained between outer layer 302 and middle layer 304 due to the welded seal 332 formed around the perimeter of panel 300. The trapped air volume is typically fixed, meaning the amount of gas stored in the secondary chamber 310 cannot be selectively increased or decreased by the user. Thus, secondary gas chamber 310 cannot be inflated or deflated. Thus, panel 300 includes an inflatable primary gas chamber 308 and a non-inflatable, or fixed, secondary gas chamber 310. Although an embodiment including primary gas chamber 308 disposed between inner layer 306 and middle layer 304 is illustrated and described herein, it will be appreciated by those of skill in the art that, in other embodiments, selectively inflatable primary gas chamber 308 may be disposed between outer layer 302 and middle layer 304, and fixed secondary gas chamber 310 may be disposed between inner layer 306 and middle layer 304, in some alternative embodiments.

In such alternative embodiments, the primary gas chamber 308 may be positioned between the inner layer 306 and the middle layer 304, as seen in FIG. 6. In some embodiments, both the primary gas chamber 308 and the secondary gas chamber 310 are selectively inflatable. In further embodiments, only the primary gas chamber 308 is selectively inflatable. In other embodiments, only the secondary gas chamber 310 is selectively inflatable.

The primary and secondary gas chambers are generally oriented in substantially parallel planes and are oriented substantially parallel to the plane of a body armor panel disposed on the body armor garment in some embodiments.

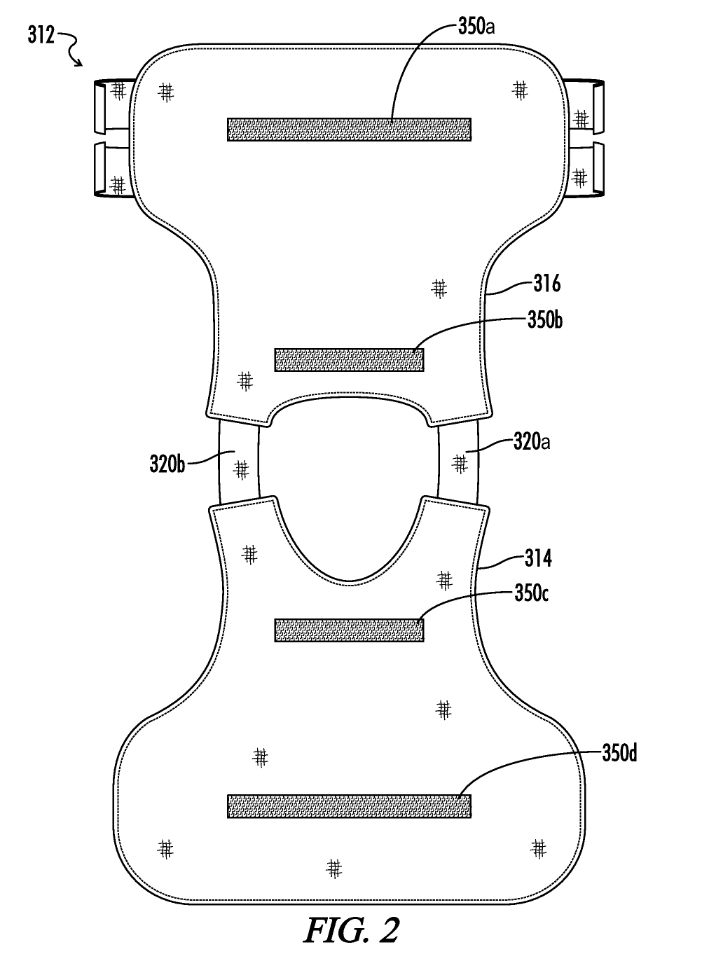

Referring now to FIG. 2, in some embodiments, a vest 312 includes a conventional ballistic or tactical vest, also referred to as a body armor garment. Vest 312 may be referred to as a body armor carrier in some embodiments and generally includes a vest front 314 and a vest rear 316. Vest front 314 is generally shaped to fit against a wearer's front torso, and vest back 316 is generally shaped to fit against a wearer's rear torso. Vest front 314 and vest rear 316 may be attached using first and second shoulder straps 320a, 320b in some embodiments. Vest 312 may include a body armor carrier without soft or hard body armor panels installed therein but capable of receiving body armor panels.

In some embodiments, the present disclosure provides a body armor system including a body armor garment having a front and a rear and including a pair of inflatable panel devices 300 as described above. The panel devices are configured for detachable securement to the interior of the body armor garment via one or more fasteners disposed between each one of the pair of panel devices and the respective front or back of the body armor garment. The panels are generally positioned to be arranged between the wearer's body and the body armor garment.

As seen in FIG. 2, in some embodiments, one or more fasteners, or attachment patches 350a, 350b, 350c, 350d may be attached to vest 312. In some embodiments, each attachment patch includes an adhesive-backed hook and loop compatible fabric patch configured to detachably engage the hook and loop fabric compatible outer fabric 336 on outer layer 302 of panel 300. Any conventional type of body armor garment, including but not limited to a body armor carrier, body armor plate, body armor apparel, helmet, etc. may be retrofitted to receive a trauma attenuating panel apparatus 300 by affixing one or more attachment patches 350 to the interior surface of the body armor garment and securing a panel device 300 to the attachment patch. For example, as seen in FIG. 2-FIG. 4, a conventional body armor garment in the form of a vest 312 includes first and second patches 350a, 350b attached to the interior surface of vest rear 316 and third and fourth patches 350c, 350d attached to the interior surface of vest front 314. As such, a first trauma attenuating panel 300a may be secured to the interior of vest front 314, as seen in FIG. 4, and a second trauma attenuating panel 300b may be secured to the interior of vest rear 316, as seen in FIG. 3. The hook and loop compatible fabric connections between each panel 300a, 300b and body armor garment 312 allow detachable installation onto and removal from body armor garment 312. Further, because substantially the entire surface of each outer layer 302 includes hook and loop compatible fabric in some embodiments, each panel 300a, 300b may be detached and interchangeably repositioned relative to vest 312 to accommodate various body sizes and shapes. Further, each panel 300a, 300b may be used interchangeably with various models and types of body armor garments.

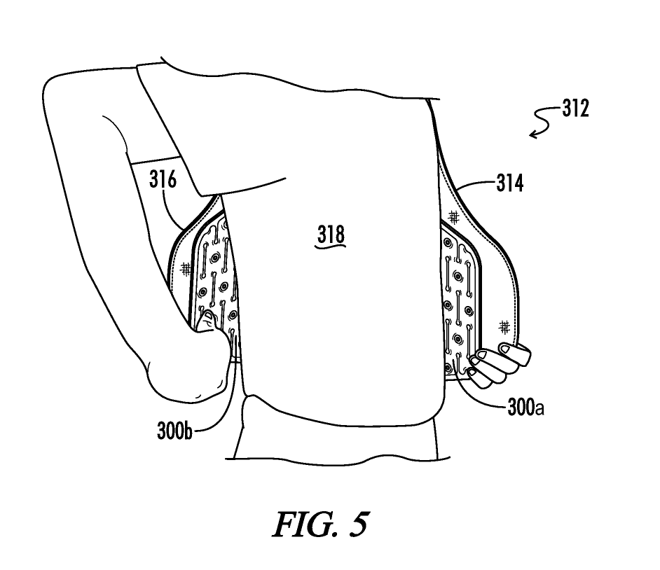

When a body armor system including body armor garment 312 is positioned on a wearer 318, as seen in FIG. 5, first panel 300a engages the front torso of the wearer, and second panel 300b engages the rear torso of the wearer 318. The first panel 300a is positioned between vest front 314 and wearer 318, and the rear panel 300b is positioned between vest rear 316 and wearer 318. Thus, each panel 300 provides a cushion between vest 312 and wearer 318 for absorbing body trauma associated with an impact on vest 312 and also for providing thermal management for the wearer during use.

A body armor system in accordance with the present disclosure in the form of a trauma attenuating vest is generally illustrated in FIG. 5 and includes conventional vest 312 retrofitted to include at least one trauma attenuating panel attached to the vest front and the vest rear.

Referring to FIG. 13, in some embodiments, a plurality of trauma attenuating panels may be formed from three discrete sheets of material forming outer, middle and inner layers 302, 304, 306. The discrete sheets may be joined in an RF welding process to form welded regions corresponding to multiple panels. Each panel may be welded and cut in an alternating upright and inverted pattern as seen in FIG. 13 to maximize usage of the sheet materials. Thus, a first trauma attenuating panel includes a first side edge shaped to be coextensive with a second side edge of an inverted second trauma attenuating panel positioned adjacent the first trauma attenuating panel.

Referring further to FIG. 1A, on some embodiments, each trauma attenuating panel device 300 includes a plurality of linear welds and a plurality of circular welds. Each circular weld surrounds a vent hole to prevent gas stored in primary and secondary gas chambers from leaking through the vent hole. Each linear weld provides an attachment between each discrete layer. In some applications, following repeated primary gas chamber inflation and deflation, or following an impact on the panel, a stress concentration may be formed at the end of each linear weld. Such a stress concentration may cause delamination of the layers at the end of the linear weld and may contribute to rupture of the primary or secondary gas chamber. To overcome the stress concentration problem, each linear weld may include a rounded weld end region on each end of the linear weld having a diameter larger than the width of the linear weld body. Each rounded weld end region can distribute stresses around each weld end more evenly and prevent stress concentration or accelerated wear that may lead to local rupture in some applications.

The panel apparatus of the present disclosure may provide a passive cooling effect in some embodiments. Experimental tests have indicated some embodiments of panel apparatus 300 in accordance with the present disclosure may reduce a wearer's local ambient body temperature between about 4.5 and about 9.1 degrees between body armor and torso.

In many applications, it may be desirable to incorporate various sensing capabilities into one or more panels 10 on a body armor system in accordance with the present disclosure. In such applications, the panel device can provide not only an energy dissipation function but it may also perform telemetry and data-gathering functions associated with environmental and physiological signals. A variety of sensors can be attached to or embedded within each panel device. In some embodiments, sensors can be attached to the exterior of a panel device either on the innermost layer adjacent the body or on the outermost layer. Sensors can also be positioned between internal layers and can be secured in place during the dielectric welding process described above for joining individual layers together. Additional circuitry and electrical connectors can also be disposed between various layers in the multilayer sheet construction of panel 10.

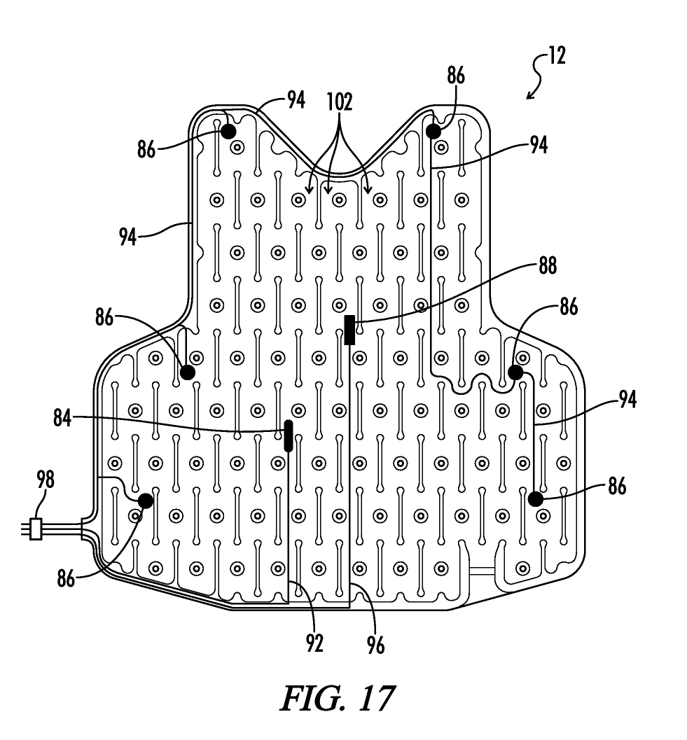

Physiological health monitoring systems can be implemented on panel device 300, seen in FIG. 1A or a second embodiment of panel device 10 seen in FIG. 14 to form a physiological health monitoring panel 12, seen for example in FIG. 17. Typically, operational readiness of an individual in a combat environment or field operation is conventionally based on a subjective assessment of the individual's physiological condition based on input from the individual and from observations of others such as co-deployed team members or remote monitoring commanders. Such subjective determinations of various factors such as physiological and mental health can be unreliable. What is needed is a wearable sensor system to monitor and store data associated with a wearer's physiological condition. In some applications, it is desirable to couple such a physiological monitoring capability with energy absorbing capability described above associated with various embodiments of a panel apparatus for wear underneath a body armor garment. A body armor system incorporating both inflatable panels for energy absorption and also physiological monitoring systems can provide a mobile platform for assessing physiological and cognitive performance during field operations.

Physiological sensors can include a life sign detection system which assess and integrates various human vital signs. Referring now to FIG. 17, in some embodiments, one or more physiological sensors can be disposed on an inside surface of panel 10 or embedded near the inside surface of panel 10.

One or more blood hemorrhage sensors 86 can be positioned on panel 10. Each blood hemorrhage sensor 86 can be connected to a connector block 98 via one or more hemorrhage sensor leads 94. Each hemorrhage sensor lead includes an electrical conductor such as a copper wire. Connector block 98 is adapted for electrical connection to an external module such as a transmitter or a data collector in some embodiments. Each hemorrhage sensor 86 is adapted to detect the presence of blood and to emit an electronic signal via hemorrhage sensor lead 94 if a pre-determined amount of blood is detected. Such a sensor would recognize whether the wearer is bleeding out into the space between the panel 10 and the torso or body 70. In some embodiments, panel 12 of the present disclosure provides generally vertical channels 102, as illustrated in FIG. 17. The spaces between adjacent welds provide corrugations, or channels 102, against the torso in some embodiments. When a wearer bleeds out into the space between the panel 12 and the body 70, blood can enter the vertical corrugations defined between the torso and the panel 12. The blood may then encounter a blood hemorrhage sensor 86 positioned at various locations on panel 12.

Also seen in FIG. 17, panel 12 in some embodiments includes one or more body heat sensors 84. Each body heat sensor 84 can be used to monitor the body temperature of the wearer of panel 12. When the body heat sensor detects a body heat greater than a predetermined level, the physical activity of the wearer can be limited. Similarly, when the body heat is lower than a predetermined level, activity can be enhanced. A heat sensor lead 92 is connected to each body heat sensor 84. Heat sensor lead 92 includes an electrically conductive wire in some embodiments. Heat sensor lead 92 can be connected to connector block 98. A voltage signal representative of the body heat of the wearer can be monitored via heat sensor lead 92.

Also seen in FIG. 17, panel 12 includes one or more heat rate sensors, or electrocardiograph, sensors 88. Each heart rate sensor can be used to monitor the heart rate of the wearer. When the heart rate becomes too high, activity can be decreased, and when the heart rate becomes too low, activity can be enhanced. A heart rate sensor lead 96 can be attached to each heart rate sensor 88. In some embodiments, heart rate sensor lead 96 can include an electrically conductive wire. Heart rate sensor lead 96 can be connected to connector block 98. A signal representative of the heart rate of the wearer is transmitted over heat rate sensor lead 96 to a data collector, a display or a transmitter for remote monitoring.

Each sensor and lead can be dielectrically welded to panel 10 onto an outer layer or between layers, including between fabric and gas barrier layers. Alternatively, each sensor and lead can be woven into the layer material or adhesively glued to one or more layers. In some embodiments, one attachment means is used to affix a sensor and a different attachment means is used to secure the associated lead. By embedding leads and/or sensors between layers using a dielectric welding process, sensors and/or leads can be shielded from environmental contaminants such as dirt, debris, moisture, chemicals, wind, etc.

An antenna system (RF, UHF, etc.) can be integrated into and/or affixed to the appropriate sheet structure layer to transmit data to various types of wireless networks, including WAN, LAN, PAN, Bluetooth, etc. Additional sensors can include respiration rate, skin temperature, and body movement sensors. Additionally, a GPS sensor and/or transmitter can be positioned on panel 10. Additionally, in some embodiments, a blast over-pressure sensor (BOP) can be attached to or in communication with first and/or second panel 10a, 10b. Blast over-pressure sensor is operable to transmit an overpressure signal representative of the presence of a blast pressure wave associated with an explosion. A piezoelectric accelerometer can also be attached to or in communication with first and/or second panel 10a, 10b. The piezoelectric accelerometer is operable to emit an accelerometer signal representative of a sudden impact force applied to the wearer of vest 12. The accelerometer signal can include a voltage or current signal in some embodiments.

Additional types of sensors that can be secured to panel 10 include radiation and chemical detection sensors. For example, a dosimeter can be attached to or in communication with first and/or second panel 10a, 10b. The dosimeter emits a radiation signal representative of environmental radiation levels. Each signal can be monitored either locally or remotely in real-time, at pre-determined sampling intervals or on-demand.

In further embodiments, the present disclosure provides a kit apparatus for retrofitting a conventional body armor garment to reduce body trauma to a wearer associated with an impact on the body armor garment, comprising. The kit includes an inflatable trauma attenuating panel including at least three discrete layers joined together to form an inflatable primary gas chamber and an independent, non-inflatable secondary gas chamber, wherein each panel includes an outer layer including a first hook and loop fabric. The apparatus also includes at least one attachment pad for detachably securing the trauma attenuating panel to the body armor garment, the attachment pad including a second hook and loop compatible fabric configured to detachably engage the first hook and loop compatible fabric.

In additional embodiments, the present disclosure provides a method of manufacturing a trauma attenuating panel, the method comprising providing at least three layers, a first layer including a hood and loop compatible fabric and a gas barrier layer, a second layer including a woven fabric and at least one gas barrier layer and a third layer including a woven fabric and a gas barrier layer. The method further includes securing the three discrete layers together to form an inflatable primary gas chamber disposed between the second and third layers and an independent non-inflatable secondary gas chamber disposed between the first and second gas layers.

In yet another embodiment, the present disclosure provides a panel apparatus for use on a canine. The device includes a panel device as describe din various embodiments above. The panel device is designed to rest against the back of a dog. Canine body armor garments may then be positioned to rest against the panel. The panel may include a plurality of vent holes for allowing passive cooling of the dog during chase or non-chase situations. The panel device can be formed of any panel construction embodiment described above, or combinations thereof.

Prototype test results indicate the panel device will also serve the canine law enforcement market. By creating a cooling and trauma attenuating panel and vest slightly smaller than standard canine body armor, the panel or vest can be placed onto the back of the dog and used to conduct thermal energy away from the dog and into the body armor above.

Additionally, the principles and embodiments of the present disclosure are provided in some embodiments as an equine saddle pad including a panel device as described in various embodiments herein and configured to be positioned on the back of a horse between the horse's body and a saddle.

Thus, it is seen that the apparatus and methods disclosed herein achieve the ends and advantages previously mentioned. Numerous changes in the arrangement and construction of the parts and steps will be readily apparent to those skilled in the art, and are encompassed within the scope and spirit of the present disclosure as defined by the appended claims.

What is claimed is:

1. A panel apparatus for attachment to a body armor garment, comprising:
an outer layer including an outer fabric and a first gas barrier layer disposed on the outer fabric;
a middle layer positioned adjacent the outer layer, the middle layer including a middle fabric having first and second middle fabric sides and including a second gas barrier layer disposed on the first middle fabric side and a third gas barrier layer disposed on the second middle fabric side;
an inner layer positioned adjacent the middle layer, the inner layer including an inner fabric having a fourth gas barrier layer disposed on the side of the inner fabric facing the middle layer;
a primary gas chamber defined between the inner layer and the middle layer; and
a secondary gas chamber defined between the outer layer and the middle layer.

2. The apparatus of claim 1, wherein:
the outer fabric comprises a hook and loop compatible material.

3. The apparatus of claim 1, further comprising:
wherein the primary gas chamber is selectively inflatable.

4. The apparatus of claim 2, further comprising:
wherein the secondary gas chamber includes a fixed volume.

5. The apparatus of claim 1, wherein:
the first gas barrier layer comprises polyurethane.

6. The apparatus of claim 5, wherein:
the middle fabric comprises nylon;
the second gas barrier layer comprises polyurethane; and
the third gas barrier layer comprises polyurethane.

7. The apparatus of claim 5, wherein:
the middle fabric comprises woven nylon with a fiber linear mass density between about 100 denier and about 1000 denier.

8. The apparatus of claim 5, wherein:
the middle fabric comprises woven nylon with a fiber linear mass density of about 200 denier.

9. The apparatus of claim 5, wherein:
the middle fabric comprises woven nylon with a fiber linear mass density of about 500 denier.

10. The apparatus of claim 5, wherein:
the inner fabric includes nylon;
the fourth gas barrier layer comprises polyurethane; and
the outer, middle and inner layers are joined by RF welding.

11. The apparatus of claim 7, wherein:
the inner fabric includes woven nylon with a fabric linear mass density between about 100 denier and about 1000 denier.

12. The apparatus of claim 7, wherein:
the inner fabric includes woven nylon with a fabric linear mass density of about 500 denier.

13. The apparatus of claim 7, wherein:
the inner fabric includes woven nylon with a fabric linear mass density of about 200 denier.

14. The apparatus of claim 1, further comprising:
an antimicrobial coating disposed on the inner fabric.

15. The apparatus of claim 14, wherein:
the antimicrobial coating further comprises a photocatalytic agent.

16. A method of retrofitting a conventional body armor garment to reduce trauma to a wearer associated with an impact on the body armor garment, the method comprising the steps of:
(a) attaching a first attachment fastener to the garment; and
(b) securing an inflatable trauma attenuating panel directly to the first attachment fastener, the panel comprising:
an outer layer including an outer fabric and a first gas barrier layer disposed on the outer fabric;
a middle layer including a middle fabric having first and second middle fabric sides and including a second gas barrier layer disposed on the first middle fabric side and a third gas barrier layer disposed on the second middle fabric side; and
an inner layer including an inner fabric having a fourth gas barrier layer disposed on the side of the inner fabric facing the middle layer,
a primary gas chamber defined between the inner layer and the middle layer; and
a secondary gas chamber defined between the outer layer and the middle layer.

17. The method of claim 16, wherein:
the second and third gas barrier layers comprise polyurethane.

18. The method of claim 16, wherein:
the first and fourth gas barrier layers comprise polyurethane,
the outer fabric includes woven nylon;
the outer, middle and inner layers are joined by RF welding.

19. An apparatus for absorbing impact forces, comprising:
a first sheet including an outer fabric and a first gas barrier layer disposed on the outer fabric;
a second sheet positioned adjacent the first sheet including a second fabric having first and second sides and including a second gas barrier layer disposed on the first side and a second gas barrier layer disposed on the second side;
a third sheet positioned adjacent the second sheet, the third sheet including a third fabric having a fourth gas barrier layer disposed on the side of the third sheet facing the second sheet;
a primary gas chamber defined between the second and third sheets,
wherein the outer fabric comprises a fastener.

20. The apparatus of claim 19, further comprising:
the fastener comprises a hook and loop compatible material.

21. The apparatus of claim 19, further comprising:
a secondary gas chamber defined between the first and second sheets.

22. The apparatus of claim 19, wherein:
the primary chamber is configured to be inflated to a pressure between about 10 psig and about 50 psig.

23. The apparatus of claim 19, wherein:
the primary chamber is configured to be inflated to a pressure between about 20 psig and about 25 psig.

24. The apparatus of claim 22, wherein:
the first, second, third and fourth gas barrier layers comprise polyurethane; and
the first, second and third sheets are joined by RF welding.
